(19) United States
(12) Patent Application Publication
(10) Pub. No.: US 2025/0205982 A1
(43) Pub. Date: Jun. 26, 2025

(54) SELF-SEALING TYRE SEALANT, METHOD FOR PRODUCING SAME, PNEUMATIC VEHICLE TYRE HAVING THE TYRE SEALANT, AND USE OF A DISPERSION OF A CROSS-LINKING AGENT IN A PLASTICISER IN THE PRODUCTION OF A TYRE SEALANT

(71) Applicant: Continental Reifen Deutschland GmbH, Hannover (DE)

(72) Inventors: Sherry-Ann Tim Kee, Seelze (DE); Xiaoke Cai, Hannover (DE)

(73) Assignee: Continental Reifen Deutschland GmbH, Hannover (DE)

(21) Appl. No.: 18/848,119

(22) PCT Filed: Mar. 13, 2023
(86) PCT No.: PCT/DE2023/200056

§ 371 Date: Sep. 17, 2024

(30) Foreign Application Priority Data
Mar. 25, 2022 (DE) 10 2022 202 949.6

(51) Int. Cl. B29C 73/16

(52) U.S. Cl. CPC B29C 73/163

(57) ABSTRACT

A self-sealing tire sealant, to a process for production thereof and to a pneumatic vehicle tire comprising the tire sealant, in addition to the use of a dispersion of a crosslinker in a plasticizer in the production of a tire sealant. The crosslinker is added to the tire sealant during production thereof in a dispersion of at least one plasticizer and the at least one crosslinker.

The invention relates to a self-sealing tire sealant, to a process for production thereof and to a pneumatic vehicle tire comprising the tire sealant.

The invention further relates to the use of a dispersion of a crosslinker in a plasticizer in the production of a tire sealant.

Self-sealing pneumatic vehicle tires are known for example from the applicant's DE 10 2006 059 286 A1. Here, standard tire constructions are subsequently provided with a sealant layer. The self-sealing sealant is a self-adhesive, viscous sealing compound which is applied as a layer from the inside in the radial direction in the projection region of the belt package to the radially innermost tire layer, the largely airtight inner layer. The sealant layer is capable of automatically sealing punctures of up to 5 millimeters in diameter. After a puncture through the tread to through the inner layer, the sealant completely surrounds the penetrating foreign body, seals the interior off from the environment and hence prevents loss of compressed air from the tire. The driver of the vehicle is not forced to replace the defective tire immediately with an equivalent replacement wheel or an emergency wheel.

The sealant features high airtightness, high tackiness and balanced flow behavior.

Other self-sealing tire sealants are disclosed, for example, in WO2020/169234 A1 and EP 3546202 B1. According to the disclosures in these documents, sealants may contain crosslinking chemicals, such as crosslinkers and crosslinking initiators. In the case of such fine chemicals, the challenge is to achieve the best possible distribution thereof in the other constituents of the tire sealant.

To this end, EP 3546202 B1 discloses adding peroxides as crosslinking initiators in a mixture of organic solvents during production of the sealant.

However, organic solvents have the disadvantage that they are volatile and have health disadvantages, such as especially irritating the respiratory tract.

Crosslinkers, such as especially quinone dioxime compounds, such as p-benzoquinone dioxime, are especially added as powders in the production of tire sealants in the prior art, as disclosed for example in EP3009260 A1. However, such pulverulent materials may be explosive, thus making handling and therefore production of sealants markedly more difficult.

Pulverulent crosslinkers, such as p-benzoquinone dioxime, are also distributable homogeneously only with great difficulty, inter alia on account of the typically relatively small amount thereof based on the total mass of sealant.

Inhomogeneous distribution of crosslinkers in tire sealants leads to inhomogeneous crosslinking and thus to undesirable properties, such as especially poorer creep behavior and low elasticity, thus adversely affecting processability and sealing effect. Outflow of sealant from the tire may occur in the worst case.

It is accordingly an object of the invention to provide a self-sealing tire sealant containing at least one crosslinker which exhibits improved creep behavior and higher elasticity. The tire sealant shall thus exhibit better processability during production and application thereof in pneumatic vehicle tires and achieve an improved sealing effect therein. Unwanted outflow of tire sealant from the tire shall also be avoided.

The tire sealant shall be produced in a manner that is as environmentally friendly and unconcerning to health as possible and be less difficult to produce.

It is a further related object of the invention to provide a pneumatic vehicle tire comprising a tire sealant which solves the above challenges having regard to production and sealing effect.

The object is achieved by the inventive tire sealant according to claim 1, by the process according to the invention for producing a tire sealant containing at least one crosslinker and by the use according to the invention of a dispersion of a crosslinker in a plasticizer in the production of a tire sealant containing at least one crosslinker. The object is further achieved by the pneumatic vehicle tire according to the invention comprising the tire sealant according to the invention.

It has surprisingly been found that a markedly improved distribution and homogeneity of the crosslinker in the tire sealant is achieved when during production of the tire sealant the at least one crosslinker is added thereto in a dispersion of at least one plasticizer and the at least one crosslinker. The tire sealant according to the invention exhibits a higher elasticity and better creep behavior. The tire sealant also exhibits an improved sealing effect, which, inter alia, avoids outflow of sealant from the tire.

The pneumatic vehicle tire according to the invention especially features increased durability after a puncture.

The sealant according to the invention and the tire according to the invention are produced in a manner that is as environmentally friendly and unconcerning to health as possible.

For the sake of simplicity, the terms “self-sealing tire sealant” and “sealant” are used synonymously unless otherwise stated in the context of the present invention.

Furthermore, for the sake of simplicity, the terms “pneumatic vehicle tire” and “tire” are used synonymously unless otherwise stated in the context of the present invention.

The constituents of the sealant according to the invention will now be more particularly
elucidated. All indications including the features of all levels of preference and embodiments of the sealant also apply for the process according to the invention for producing the sealant and for the pneumatic vehicle tire according to the invention, including in terms of the combination of features of all levels of preference and embodiments of the sealant with features of all levels of preference and embodiments of the process and of the tire unless explicitly stated otherwise. Furthermore, all indications including the features of all levels of preference and embodiments also apply for the use according to the invention.

All of the resulting combinations of features are encompassed by the present invention.

The invention further comprises all combinations of different features of identical or different levels of preference and embodiments of the sealant with one another.

The reported amounts of the constituents of the sealant in % by weight are in each case based on the total amount of sealant unless otherwise stated.

The reported amounts of the constituents of the dispersion in % by weight, especially crosslinkers and plasticizers, are based on the total amount of the dispersion.

According to the invention, the at least one crosslinker is added to the tire sealant during production thereof in a dispersion of at least one plasticizer and the at least one crosslinker.

The tire sealant, the crosslinker and the plasticizer may in principle be any types known to those skilled in the art which are suitable for pneumatic vehicle tires.

The plasticizer may be any plasticizers known to those skilled in the art, in particular oils, such as especially vegetable oils, such as especially rapeseed oil, aromatic, naphthenic or paraffinic mineral oil plasticizers, for example MES (mild extracted solvate) or paraffin oil (white mineral oil) or RAE (residual aromatic extract) or TDAE (treated distillate aromatic extract) or rubber-to-liquid oils (RTL) or biomass-to-liquid oils (BTL) preferably having a content of polycyclic aromatics of less than 3% by weight according to the method IP 346. Mineral oils are particularly preferred as plasticizers.

The plasticizer of the dispersion is preferably an oil
which is preferably selected from the group consisting of paraffin oil, MES (mild extracted solvate), wherein paraffinic MES is particularly preferred, and vegetable oils, wherein rapeseed oil is particularly preferred.

An oil as plasticizer achieves a particularly good distribution of the crosslinker in the plasticizer and thus of the dispersion in the tire sealant. At the same time, oils, especially those selected from the group consisting of paraffin oil, MES (mild extracted solvate), wherein paraffinic MES is particularly preferred, and vegetable oils, wherein rapeseed oil is particularly preferred,
are particularly compatible with such tire sealants and these feature excellent properties in terms of sealing effect, flow behavior and tackiness.

Oils, especially those selected from the group consisting of paraffin oil, MES (mild extracted solvate), wherein paraffinic MES is particularly preferred, and vegetable oils, wherein rapeseed oil is particularly preferred,
are also relatively environmentally friendly and unconcerning to health and do not tend to evaporate at an early stage like organic solvents.

In particularly advantageous embodiments, the oil is a paraffinic mineral oil, in particular paraffin oil.

It is preferable when the crosslinker is selected from the group consisting of quinone dioxime compounds, quinones, divinylbenzene and 1,4-dinitrosobenzene, wherein quinone dioxime compounds and in particular p-benzoquinone dioxime (QDO) are particularly preferred.

This makes it possible to achieve particularly good crosslinking of the sealant and thus excellent properties in terms of sealing effect and flow behavior.

It is preferable when the dispersion contains
50% to 80% by weight of crosslinkers and
20% to 50% by weight of plasticizers.

The dispersion may optionally contain further constituents, for example chalk. The dispersion preferably contains at most up to 5% by weight of further constituents.

In advantageous embodiments, the dispersion contains no further constituents, i.e. 0% by weight of further constituents.

The reported amounts in % by weight are based on the total amount of dispersion.

It is particularly preferable when the dispersion contains
60% to 70% by weight, for example 65% by weight, of crosslinkers and
30% to 40% by weight, for example 35% by weight, of plasticizers and optionally up to
5% by weight of further constituents, for example chalk.

In advantageous embodiments, the dispersion contains no further constituents, i.e. 0% by weight of further constituents.

The reported amounts in % by weight are based on the total amount of dispersion.

In preferred embodiments, the dispersion contains
60% to 70% by weight, for example 65% by weight, of p-benzoquinone dioxime (QDO), and
30% to 40% by weight, for example 35% by weight, of oil, preferably paraffinic mineral oil, in particular paraffin oil.

In advantageous embodiments, the dispersion contains no further constituents, i.e. 0% by weight of further constituents.

The reported amounts in % by weight are based on the total amount of dispersion.

The reported amounts of the constituents of the dispersion are to be understood and selected such that they equal 100% by weight.

The underlying object of the invention is particularly readily achieved with the preferred and particularly preferred amounts of crosslinkers and plasticizers.

There is especially a homogeneous distribution of the crosslinker in the sealant, wherein the sealant features a high elasticity as a result of a higher and more homogeneous degree of crosslinking.

The self-sealing tire sealant preferably contains
d) 0.5% to 7% by weight, particularly preferably 1.5% to 5% by weight, of the dispersion of at least one plasticizer and the at least one crosslinker, wherein the amounts in % by weight are based here on the total amount of tire sealant.

It is preferable when the self-sealing tire sealant is based on the crosslinking of at least one polyolefin and/or rubber with the at least one crosslinker.

This achieves a particularly high compatibility of the sealant with the pneumatic vehicle tire, in particular the inner layer thereof. At the same time, such a sealant is particularly readily adjustable to different requirements of different tire types, thus resulting in each case in exceptional properties in terms of sealing effect, flow behavior and tackiness.

In advantageous embodiments, the sealant contains at least one rubber.

The rubber may be selected from any rubber types known to those skilled in the art. A mixture of different rubbers is also conceivable.

In a preferred embodiment of the invention, the rubber is natural rubber (NR) and/or butadiene rubber (BR) and/or isoprene rubber (IR) and/or styrene-butadiene rubber (SBR) and/or polychloroprene (CR) and/or butyl rubber (IIR) and/or bromobutyl rubber (BIIR) and/or chlorobutyl rubber (CIIR) and/or silicone rubber.

These rubber types are particularly well suited for the processing temperatures during the production of the sealant and later during the use, in particular in the pneumatic vehicle tire.

It is particularly preferable when the self-sealing tire sealant contains at least one butyl rubber (IIR). As is known to those skilled in the art, butyl rubber is a copolymer of isobutene and isoprene.

The butyl rubber present in the sealant preferably has an isoprene content of 0.5 to 5 mol %. A person skilled in the art is aware that the isoprene content simultaneously represents the proportion of unsaturated carbon-carbon bonds in the polymer chains in the butyl rubber. The higher the isoprene content, the higher the crosslinking potential of the rubber and thus of the polymer matrix in the sealant on account of the elevated unsaturated proportion.

In preferred embodiments, the sealant contains a butyl rubber having an isoprene content of 2.3 to 5.0 mol %.

This comparatively high isoprene proportion achieves a higher level of crosslinking and improved airtightness.

At the same time, especially in the case of inhomogeneous distribution of crosslinking chemicals, this demands an elevated amount of crosslinker and optionally crosslinking initiator and/or an inhomogeneous distribution of crosslinker becomes more noticeable with an elevated isoprene content in the butyl rubber.

With the dispersion of crosslinker and plasticizer and the resulting more homogeneous distribution of crosslinker in the sealant, the invention thus also makes it possible to employ a butyl rubber having an isoprene content of 2.3 to 5.0 mol % and the associated advantages thereof.

The invention thus makes it possible to extract the full crosslinking potential which is achieved due to the presence of a butyl rubber having an isoprene content of 2.3 to 5.0 mol %.

The more homogeneous distribution of the dispersion means it may not be necessary to employ an elevated amount of crosslinkers or the amount of crosslinkers may be matched precisely to the isoprene content so that neither crosslinker nor unsaturated sites of the polymer chains are wasted.

The self-sealing tire sealant preferably contains
a) 9% to 50% by weight, particularly preferably 12% to 50% by weight, of at least one rubber, wherein the rubber is preferably butyl rubber (IIR).

In particularly preferred embodiments, the sealant a) contains 20.5% to 40% by weight, particularly preferably 20.5% to 29.5% by weight, of at least one butyl rubber.

The sealant thus has a particularly good profile of properties comprising sealing effect, flow behavior and tackiness and in particular very good airtightness. These relatively large amounts of butyl rubber in the sealant simultaneously have the advantage that elevated crosslinking and improved airtightness are achievable when using a butyl rubber having an isoprene content of 2.3 to 5.0 mol %.

In advantageous embodiments, the sealant contains at least one polyolefin.

This achieves optimal flow behavior coupled with good producibility (processability) of the sealant.

The at least one polyolefin preferably has a number-average molecular weight distribution Mn according to GPC of 400 to 2500 g/mol, particularly preferably 800 to 2500 g/mol, very particularly preferably 800 to 1600 g/mol, in turn preferably 1200 to 1600 g/mol, in turn particularly preferably 1200 to 1400 g/mol, for example 1300 g/mol.

A polyolefin having the recited ranges for Mn is particularly suitable for achieving the desired flowability and also the sealing effect of the sealant in the event of a puncture.

The term “polyolefins” is especially to be understood as meaning polyalkenes obtained by polymerization of in particular unbranched alkenes, such as polyethylenes, polypropylenes, polybutenes and polyisobutenes.

The at least one polyolefin is particularly preferably at least one polybutene.

This establishes the tackiness of the finished sealant and determines the flowability in the production process as well as the local stationarity of the finished sealant.

The at least one polyolefin may also be a mixture of two or more polybutenes each having an Mn of 400 to 2500 g/mol, wherein the polybutenes may differ in their Mn.

Suitable polybutenes, also known as polybutylene, are obtainable for example under the trade name Indopol® polybutenes from INEOS Capital Limited.

A mixture of at least one polybutene with at least one other polyolefin is also conceivable.

The self-sealing tire sealant preferably contains
b) 11% to 80% by weight of at least one polyolefin, wherein the polyolefin is preferably polybutene.

In particularly advantageous embodiments, the sealant contains b) 14.5% to 65% by weight of at least one polyolefin.

The sealant may further contain constituents, such as in particular crosslinking initiators, filler(s), tackifiers, further plasticizers, for example oil(s), and optionally further additives, for example color pigments and/or zinc oxide and/or sulfur.

In preferred embodiments of the invention, the sealant contains at least one filler, in particular at least one active filler.

The filler is preferably selected from carbon blacks and silicon dioxide.

The silicon dioxide is preferably amorphous silicon dioxide, for example precipitated silica, which is also referred to as precipitated silicon dioxide. However, it is alternatively also possible to use fumed silicon dioxide for example.

The filler is particularly preferably carbon black.

Suitable carbon blacks include any carbon black types known to those skilled in the art. It is preferable when the carbon black is selected from industrial carbon blacks and pyrolysis carbon blacks, wherein industrial carbon blacks are more preferred.

This has the advantage that the cohesion of the sealant is increased and the tackiness of the sealant during the production process is reduced. The stationarity and the tear properties of the sealant are simultaneously improved.

In advantageous embodiments of the invention, a carbon black having an iodine adsorption number according to ASTM D 1510 of 20 to 180 g/kg, particularly preferably 30 to 140 g/kg, and a DBP number according to ASTM D 2414 of 30 to 200 ml/100 g, preferably 90 to 180 ml/100 g, particularly preferably 110 to 180 ml/100 g, is employed.

In further preferred embodiments of the invention, an N326-type carbon black is used.

A mixture of two or more carbon blacks is also conceivable.

The self-sealing tire sealant preferably contains
c) 2% to 15% by weight of at least one filler, wherein the filler is preferably selected from carbon blacks and silicon dioxide, wherein carbon black is particularly preferred.

With the recited amounts, the sealant exhibits particularly good stationarity on account of the optimized creep behavior, very good sealing effect and very good tear properties.

In preferred embodiments of the invention, the sealant contains at least one crosslinking initiator.

A crosslinking initiator is a chemical compound that initiates the crosslinking of the sealant.

The at least one crosslinking initiator is preferably selected from the group consisting of lead oxide, other metal oxides and peroxides, wherein peroxides are particularly preferred.

The peroxide(s) are preferably selected from the group consisting of diaroyl peroxides, diacyl peroxides and peroxyesters.

The crosslinking initiator may be added as pure substance or in a mixture with for example a stabilizer, such as dibutyl maleate.

A mixture of 50% by weight of dibenzoyl peroxide and 50% by weight of dibutyl maleate as stabilizer is conceivable, for example.

It is further conceivable for the crosslinking initiator to be added in a liquid as described in EP 3546202 B1, for example in a weight fraction of 35% to 40% by weight.

In all mixtures, only the amount of the peroxide present is included in the reported amount of crosslinking initiator in the sealant, that is to say for example that in the recited amounts of at least one crosslinking initiator, concomitant substances such as dibutyl maleate or the liquid are not included.

The self-sealing tire sealant preferably contains
e) 0.5% to 8% by weight, preferably 0.5 to 6% by weight, of at least one crosslinking initiator.

The combination of a crosslinker with a crosslinking initiator in the reported amounts in particular achieves a particularly effective tire sealant which seals rapidly in the event of a puncture and is further optimizable for tires having different internal pressures.

In advantageous embodiments, the sealant contains at least one tackifier, especially in the case where the sealant does not already exhibit a sufficient tackiness on account of the constituents, in particular the polymers, present. The term “tackifier” is in principle to be understood as meaning any substance which increases the tackiness of the sealant.

In advantageous embodiments of the invention, the tackifier is at least one hydrocarbon resin.

It will be clear to those skilled in the art that hydrocarbon resins are polymers constructed from monomers, wherein the hydrocarbon resin is formally constructed from derivatives of the monomers by linkage of the monomers to one another.

The term “hydrocarbon resins” in the context of the present application encompasses resins which comprise carbon atoms and hydrogen atoms and may optionally comprise heteroatoms, such as oxygen atoms in particular.

The hydrocarbon resin is preferably selected from the group consisting of phenolic resins, further aromatic resins, preferably alpha-methylstyrene-styrene resins and/or indene-coumarone resins, aliphatic resins, preferably C5-resins, and rubber resins, in particular colophony and/or balsam resins. The tackifier is particularly preferably an aliphatic C5-resin.

The self-sealing tire sealant preferably contains
f) 1.5% to 10% by weight of at least one tackifier.

Such amounts further optimize the tackiness and the viscosity of the sealant.

It is preferable when the self-sealing tire sealant also contains
g) up to 1.1% by weight of zinc oxide, in particular 0.1% to 1.1% by weight.

Zinc oxide improves the stability of crosslinking sites in terms of longevity and with respect to heat.

In advantageous embodiments, the self-sealing tire sealant also contains at least one further plasticizer, in particular to further optimize the sealant in terms of processability, according to the composition of its other constituents.

The further plasticizer may be any plasticizers known to those skilled in the art, in particular oils, such as in particular aromatic, naphthenic or paraffinic mineral oil plasticizers, for example MES (mild extracted solvate) or RAE (residual aromatic extract) or TDAE (treated distillate aromatic extract) or rubber-to-liquid oils (RTL) or biomass-to-liquid oils (BTL) preferably having a content of polycyclic aromatics of less than 3% by weight according to the method IP 346. Mineral oils are particularly preferred as plasticizers.

When using mineral oil, this is preferably selected from the group consisting of DAE (distillate aromatic extracts), RAE (residual aromatic extract), TDAE (treated distillate aromatic extracts), MES (mild extracted solvate) and naphthenic oils.

It is particularly preferable to employ MES (mild extracted solvate) as the further plasticizer, wherein paraffinic MES (mild extracted solvate) is particularly preferable here too.

In preferred embodiments, the self-sealing tire sealant contains
h) 0.5% to 8% by weight of oil as further plasticizer.

In further preferred embodiments, the self-sealing tire sealant contains no further plasticizer, i.e. 0% by weight of further plasticizers, in addition to the plasticizer already present in the dispersion.

In advantageous embodiments, the inventive addition of the dispersion of crosslinker in plasticizer thus simultaneously makes it possible to eschew addition of further plasticizer.

This eliminates the need for weighing and addition of a further constituent.

It is preferable when the self-sealing tire sealant also contains up to 1% by weight, in particular 0.1% to 1.0% by weight, of sulfur.

This increases the high temperature stability of crosslinking sites.

In preferred embodiments, the sealant thus contains the constituents: butyl rubber, polyolefin, filler, dispersion of crosslinker and plasticizer, crosslinking initiator, tackifier, filler and optionally further plasticizers, zinc oxide and sulfur.

All indications and preferred features of all levels of preference apply for the type and amount of the constituents.

In particularly preferred embodiments, the sealant contains the constituents according to the specified features a) to i) in combination with one another. All indications and preferred features of all levels of preference apply for the type and amount of the constituents.

In a particularly advantageous embodiment of the invention, the self-sealing tire sealant contains at least the following constituents:
a1) 12% to 22% by weight of at least one rubber, wherein the rubber is preferably butyl rubber, wherein the butyl rubber preferably has an isoprene content of 0.5 to 2.3 mol %, and
b1) 58% to 78% by weight of at least one polyolefin and
c1) 4% to 8% by weight of at least one filler and
d1) 0.5% to 2.5% by weight of the dispersion of at least one plasticizer and the at least one crosslinker, wherein the dispersion contains 50% to 80% by weight of crosslinkers and 20% to 50% by weight of plasticizers, and
e1) 1.5% to 3.5% by weight of at least one crosslinking initiator and
f1) 1.5% to 4.5% by weight of at least one tackifier.

It is preferable when this sealant additionally contains
g1) 0.3% to 1.1% by weight of zinc oxide and
h1) 0.5% to 2.5% by weight of oil and
optionally i1) up to 0.6% by weight of sulfur, in particular 0.1% to 0.6% by weight of sulfur.

Such a sealant having the composition a1) to i1) is particularly suitable for passenger car tires.

One aspect of the invention is a passenger car tire which comprises the sealant having the composition a1) to i1) at least on the inner surface opposite the tread.

The aforementioned features regarding type and optionally amount including all embodiments and levels of preference also apply for the constituents a1) to i1).

For example, also in

the constituent “b1) 58% to 78% by weight of at least one polyolefin”, the polyolefin is preferably polybutene.

In a further particularly advantageous embodiment of the invention, the self-sealing tire sealant contains at least the following constituents:
a2) 13.5% to 29.5% by weight, preferably 20.5% to 29.5% by weight, of at least one rubber, wherein the rubber is preferably butyl rubber, wherein the butyl rubber preferably has an isoprene content of 0.5 to 2.3 mol %, and
b2) 47% to 77% by weight of at least one polyolefin and
c2) 2.5% to 7.5% by weight of at least one filler and
d2) 1% to 4% by weight of the dispersion of at least one plasticizer and the at least one crosslinker, wherein the dispersion contains 50% to 80% by weight of crosslinkers and 20% to 50% by weight of plasticizers, and
e2) 2% to 4% by weight of at least one crosslinking initiator and
f2) 1.5% to 4.5% by weight of at least one tackifier.

It is preferable when this sealant additionally contains
optionally g2) up to 1.0% by weight of zinc oxide, in particular 0.1% to 1.0% by weight of zinc oxide, and
optionally h2) up to 4% by weight of oil, in particular 0.5% to 4% by weight of oil, and
optionally i2) up to 1.0% by weight of sulfur, in particular 0.1% to 1.0% by weight of sulfur.

Such a sealant having the composition a2) to i2) is particularly suitable for van tires.

One aspect of the invention is a van tire which comprises the sealant having the composition a2) to i2) at least on the inner surface opposite the tread.

The aforementioned features regarding type and optionally amount including all embodiments and levels of preference also apply for the constituents a2) to i2).

In a further particularly advantageous embodiment of the invention, the self-sealing tire sealant contains at least the following constituents:
a3) 15.5% to 35.5% by weight of at least one rubber, wherein the rubber is preferably butyl rubber, wherein the butyl rubber preferably has an isoprene content of 0.5 to 5 mol %, and
b3) 40% to 70% by weight of at least one polyolefin and
c3) 2.5% to 7.5% by weight of at least one filler and
d3) 2% to 5% by weight of the dispersion of at least one plasticizer and the at least one crosslinker, wherein the dispersion contains 50% to 80% by weight of crosslinkers and 20% to 50% by weight of plasticizers, and
e3) 2.5% to 5.5% by weight of at least one crosslinking initiator and
f3) 1.5% to 5.5% by weight of at least one tackifier.

It is preferable when this sealant additionally contains
optionally g3) up to 1.0% by weight of zinc oxide, in particular 0.1% to 1.0% by weight of zinc oxide, and
optionally h3) up to 5% by weight of oil, in particular 0.5% to 5% by weight of oil, and
optionally i3) up to 1.0% by weight of sulfur, in particular 0.1% to 1.0% by weight of sulfur.

Such a sealant having the composition a3) to i3) is particularly suitable for truck tires.

One aspect of the invention is a truck tire which comprises the sealant having the composition a3) to i3) at least on the inner surface opposite the tread.

The aforementioned features regarding type and optionally amount including all embodiments and levels of preference also apply for the constituents a3) to i3).

In a further particularly advantageous embodiment of the invention, the self-sealing tire sealant contains at least the following constituents:
a4) 26% to 50% by weight of at least one rubber, wherein the rubber is preferably butyl rubber, wherein the butyl rubber preferably has an isoprene content of 0.5 to 5 mol %, and
b4) 14.5% to 54.5% by weight of at least one polyolefin and
c4) 3% to 9% by weight of at least one filler and
d4) 3% to 7% by weight of the dispersion of at least one plasticizer and the at least one crosslinker, wherein the dispersion contains 50% to 80% by weight of crosslinkers and 20% to 50% by weight of plasticizers, and
e4) 4% to 8% by weight of at least one crosslinking initiator and
f4) 2% to 7% by weight of at least one tackifier.

It is preferable when this sealant additionally contains
optionally g4) up to 1.0% by weight of zinc oxide, in particular 0.1% to 1.0% by weight of zinc oxide, and
h4) 2% to 8% by weight of oil and
optionally i4) up to 1.0% by weight of sulfur, in particular 0.1% to 1.0% by weight of sulfur.

Such a sealant having the composition a4) to i4) is particularly suitable for agricultural tires or construction site tires, such as a tire for agricultural tractors, self-propelled harvesters, trailers, wheel loaders or excavators.

One aspect of the invention is an agricultural tire or construction site tire which comprises the sealant having the composition a4) to i4) at least on the inner surface opposite the tread.

The aforementioned features regarding type and optionally amount including all embodiments and levels of preference also apply for the constituents a4) to i4).

In addition, as previously mentioned multiple times, all further indications relating to these features also apply for the compositions a1) to i1), a2) to i2), a3) to i3) and a4) to i4).

It is thus preferably the case especially for all of the recited embodiments that the polyolefin is a polybutene, the filler is a carbon black, the tackifier is a hydrocarbon resin, the crosslinking initiator is a peroxide, etc.

It is especially the case for all of the recited embodiments that the plasticizer is preferably an oil, particularly preferably selected from the group consisting of paraffin oil, MES (mild extracted solvate), wherein paraffinic MES is particularly preferred, and vegetable oils, wherein rapeseed oil is particularly preferred.

In particularly advantageous embodiments, the oil is a paraffinic mineral oil, in particular paraffin oil.

It is especially the case for all of the recited embodiments that the crosslinker is selected from the group consisting of quinone dioxime compounds, quinones, divinylbenzene and 1,4-dinitrosobenzene, wherein quinone dioxime compounds and in particular
p-benzoquinone dioxime (QDO) are particularly preferred.

The process according to the invention for producing a self-sealing tire sealant containing at least one crosslinker comprises at least the following process steps:
X1) producing or providing a dispersion of at least one crosslinker in at least one plasticizer,
X2) providing further constituents, such as preferably at least one polyolefin and/or at least one rubber in one or more process steps,
X3) adding the dispersion from step X1) to the constituents from step X2).

The dispersion in step X1) is commercially available, for example a dispersion of 60% to 65% by weight of p-benzoquinone dioxime and 35% to 40% by weight of oil, which may optionally contain up to 5% by weight of chalk and is obtainable under the trade name QDO 65MK from LORD Germany Feinchemie GmbH.

If the dispersion in step X1) is not commercially available, it may be produced as follows:
X01) providing at least one crosslinker, wherein the crosslinker is selected from the group consisting of quinone dioxime compounds, quinones, divinylbenzene and 1,4-dinitrosobenzene, wherein quinone dioxime compounds and in particular p-benzoquinone dioxime (QDO) are particularly preferred, and
X02) providing at least one plasticizer, wherein the plasticizer is preferably an oil which is preferably selected from the group consisting of paraffin oil, MES (mild extracted solvate), wherein paraffinic MES is particularly preferred, and vegetable oils, wherein rapeseed oil is particularly preferred, and
X03) intensively dispersing the crosslinker from step X01) with the plasticizer from step X02) to obtain a dispersion of at least one crosslinker in at least one plasticizer.

In an exemplary and advantageous embodiment of the invention, process step X2) comprises at least the following process steps:
X2-1) mixing at least one rubber with at least one filler to produce a masterbatch and
X2-2) mixing the masterbatch with at least one polyolefin to produce a component A and
X2-3) mixing at least one crosslinking initiator with at least one polyolefin to obtain a component B and
X2-4) mixing component A and component B to produce the tire sealant.

The adding of the dispersion according to step X3) is preferably carried out during step X2-1).

The mixing of the components according to all of the steps is carried out in apparatuses known to those skilled in the art.

The mixing in step X2-2) is preferably carried out in an extruder, preferably a twin screw extruder.

The mixing in step X2-3) is preferably carried out in a mixing tank.

The mixing in step X2-4) is preferably carried out in a static mixer.

As mentioned above, the present invention further provides a pneumatic vehicle tire which comprises the tire sealant according to the invention inclusive of all recited indications, at least on the inner surface opposite the tread.

As mentioned above, the present invention further provides for the use of a dispersion of at least one crosslinker, preferably
p-benzoquinone dioxime, in at least one plasticizer, preferably selected from the group consisting of paraffin oil, MES (mild extracted solvate), wherein paraffinic MES is particularly preferred, and vegetable oils, wherein rapeseed oil is particularly preferred,
in the production of a self-sealing tire sealant.

The invention shall now be more particularly elucidated with reference to exemplary embodiments.

Table 1 shows the hysteresis behavior using the average tan delta value at 100° C. and the creep behavior for an inventive sealant E1 and a comparative sealant V1.

The reported amounts of the constituents are specified in % by weight. E1 was produced using the process according to the aforementioned steps X1) to X3) including X2-1) to X2-4), wherein the dispersion was added in step X2-1). V1 was produced according to X2-1) to X-2-4), wherein the crosslinker was added in step X2-1).

The properties were determined using the following methods:
Average tan delta from frequency sweep at 100° C.
Vertical creep: measured creep length: Length in millimeters (mm) of a crept specimen after vertical creep at 125° C.

The values for tan delta and creep length were determined by taking the average of two specimens in each case.

TABLE 1

| | V1 | E1 | E2 |
|---|---|---|---|
| Constituents | | | |
| Butyl rubber ¹⁾ | 17 | 17 | — |
| Butyl rubber ²⁾ | — | — | 21.5 |
| Polybutene | 68 | 68 | 62 |
| N326 carbon black | 6.0 | 6.0 | 5.0 |
| Crosslinker: Powder ³⁾ | 0.975 | — | — |
| Crosslinker: Dispersion ⁴⁾ | — | 1.5 | 2.5 |
| Peroxide ⁵⁾ | 2.5 | 2.5 | 3.0 |
| Further constituents ⁶⁾ | 5.0 | 5.0 | 6.0 |
| Properties | | | |
| Tan delta | 0.7 | 0.6 | 0.4 |
| Vertical creep | 3.3 | 3.1 | 1.0 |

¹⁾ Butyl rubber: Isoprene content 1.85 mol %
²⁾ Butyl rubber: Isoprene content 2.3 mol %
³⁾ p-benzoquinone dioxime: powder
⁴⁾ p-benzoquinone dioxime: dispersion: QDO 65MK, LORD Germany Feinchemie GmbH
⁵⁾ Peroxide: mixture of 50% by weight of dibenzoyl peroxide and 50% by weight of dibutyl maleate
⁶⁾ Further constituents:
For V1 and E1: 3% by weight of aliphatic C₅-resin, 0.7% by weight of zinc oxide, 1.0% by weight of paraffinic MES oil, 0.3% by weight of sulfur;
For E2: 3% by weight of aliphatic C₅-resin, 0.5% by weight of zinc oxide, 2.0% by weight of paraffinic MES oil, 0.5% by weight of sulfur.

As is apparent from table 1, the inventive sealant achieves a lower tan delta at 100° C. This suggests better and more homogeneous crosslinking.

E1 also shows improved, i.e. reduced, creep behavior.

This entails improved processability of the sealant during its production and during application in pneumatic vehicle tires. Undesired outflow of sealant from the tire is simultaneously prevented or at least the risk thereof is markedly reduced.

1. A self-sealing tire sealant containing at least one crosslinker, wherein the at least one crosslinker is added to the tire sealant during production thereof in a dispersion of at least one plasticizer and the at least one crosslinker.

2. The self-sealing tire sealant as claimed in claim 1, wherein the plasticizer is an oil which is preferably selected from the group consisting of paraffin oil, MES (mild extracted solvate), wherein paraffinic MES is particularly preferred, and vegetable oils, wherein rapeseed oil is particularly preferred.

3. The self-sealing tire sealant as claimed in claim 1, wherein the crosslinker is selected from the group consisting of quinone dioxime compounds, quinones, divinylbenzene and 1,4-dinitrosobenzene, wherein quinone dioxime compounds and in particular
p-benzoquinone dioxime are particularly preferred.

4. The self-sealing tire sealant as claimed in claim 1, wherein the dispersion contains 50% to 80% by weight, preferably 60% to 70% by weight, of crosslinkers and 20% to 50% by weight, preferably 30% to 40% by weight, of plasticizers, wherein the reported amounts in % by weight are based on the total amount of dispersion.

5. The self-sealing tire sealant as claimed in claim 1, wherein it is based on the crosslinking of at least one polyolefin and/or rubber with the at least one crosslinker.

6. The self-sealing tire sealant as claimed in claim 1, wherein it contains
a) 9% to 50% by weight, preferably 12% to 50% by weight, particularly preferably 20.5% to 40% by weight, of at least one rubber, wherein the rubber is preferably butyl rubber (IIR), wherein the butyl rubber preferably has an isoprene content of 0.5 to 5 mol %.

7. The self-sealing tire sealant as claimed in claim 1, wherein it contains
b) 11% to 80% by weight, preferably 14.5% to 65% by weight, of at least one polyolefin, wherein the polyolefin is preferably polybutene.

8. The self-sealing tire sealant as claimed in claim 1, wherein it contains
c) 2% to 15% by weight of at least one filler, wherein the filler is preferably selected from carbon blacks and silicon dioxide, wherein carbon black is particularly preferred.

9. The self-sealing tire sealant as claimed in claim 1, wherein it contains
d) 0.5% to 7% by weight, preferably 1.5% to 5% by weight, of the dispersion of at least one plasticizer and the at least one crosslinker.

10. The self-sealing tire sealant as claimed in claim 1, wherein it contains
e) 0.5% to 8% by weight, preferably 0.5% to 6% by weight, of at least one crosslinking initiator, wherein the crosslinking initiator is preferably selected from the group consisting of lead oxide, other metal oxides and peroxides, wherein peroxides are particularly preferred.

11. The self-sealing tire sealant as claimed in claim 1, wherein it contains
f) 1.5% to 10% by weight of at least one tackifier, wherein the tackifier is preferably a hydrocarbon resin which is preferably selected from the group consisting of phenolic resins, further aromatic resins, preferably alpha-methylstyrene-styrene resins and/or indene-coumarone resins, aliphatic resins, preferably Cs-resins, and rubber resins, in particular colophony and/or balsam resins.

12. The self-sealing tire sealant as claimed in claim 1, wherein it contains at least the following constituents:
a1) 12% to 22% by weight of at least one rubber, wherein the rubber is preferably butyl rubber, wherein the butyl rubber preferably has an isoprene content of 0.5 to 2.5 mol %, and
b1) 58% to 78% by weight of at least one polyolefin and
c1) 4% to 8% by weight of at least one filler and
d1) 0.5% to 2.5% by weight of the dispersion of at least one plasticizer and the at least one crosslinker, wherein the dispersion contains 50% to 80% by weight of crosslinkers and 20% to 50% by weight of plasticizers, and
e1) 1.5% to 3.5% by weight of at least one crosslinking initiator and
f1) 1.5% to 4.5% by weight of at least one tackifier.

13. The self-sealing tire sealant as claimed in claim 1, wherein it contains at least the following constituents:
a2) 13.5% to 29.5% by weight, preferably 20.5% to 29.5% by weight, of at least one rubber, wherein the rubber is preferably butyl rubber, wherein the butyl rubber preferably has an isoprene content of 0.5 to 2.5 mol %, and
b2) 47% to 77% by weight of at least one polyolefin and
c2) 2.5% to 7.5% by weight of at least one filler and
d2) 1% to 4% by weight of the dispersion of at least one plasticizer and the at least one crosslinker, wherein the dispersion contains 50% to 80% by weight of crosslinkers and 20% to 50% by weight of plasticizers, and
e2) 2% to 4% by weight of at least one crosslinking initiator and
f2) 1.5% to 4.5% by weight of at least one tackifier.

14. The self-sealing tire sealant as claimed in claim 1, wherein it contains at least the following constituents:
a3) 15.5% to 35.5% by weight of at least one rubber, wherein the rubber is preferably butyl rubber, wherein the butyl rubber preferably has an isoprene content of 0.5 to 5 mol %, and
b3) 40% to 70% by weight of at least one polyolefin and
c3) 2.5% to 7.5% by weight of at least one filler and
d3) 2% to 5% by weight of the dispersion of at least one plasticizer and the at least one crosslinker, wherein the dispersion contains 50% to 80% by weight of crosslinkers and 20% to 50% by weight of plasticizers, and
e3) 2.5% to 5.5% by weight of at least one crosslinking initiator and
f3) 1.5% to 5.5% by weight of at least one tackifier.

15. The self-sealing tire sealant as claimed in claim 1, wherein it contains at least the following constituents:
a4) 26% to 50% by weight of at least one rubber, wherein the rubber is preferably butyl rubber, wherein the butyl rubber preferably has an isoprene content of 0.5 to less than 5 mol %, and
b4) 14.5% to 54.5% by weight of at least one polyolefin and
c4) 3% to 9% by weight of at least one filler and
d4) 3% to 7% by weight of the dispersion of at least one plasticizer and the at least one crosslinker, wherein the dispersion contains 50% to 80% by weight of crosslinkers and 20% to 50% by weight of plasticizers, and
e4) 4% to 8% by weight of at least one crosslinking initiator and
f4) 2% to 7% by weight of at least one tackifier.

16. A process for producing a self-sealing tire sealant containing at least one crosslinker, wherein the process comprises at least the following process steps:
X1) producing or providing a dispersion of at least one crosslinker in at least one plasticizer,
X2) providing further constituents, such as preferably at least one polyolefin and/or at least one rubber in one or more process steps,
X3) adding the dispersion from step X1) to the constituents from step X2).

17. A pneumatic vehicle tire which comprises the tire sealant as claimed in claim 1 at least on the inner surface opposite the tread.

18. The process according to claim 16, wherein the dispersion of the at least one crosslinker,
includes p-benzoquinone dioxime, in at least one plasticizer, preferably selected from the group consisting of paraffin oil, MES (mild extracted solvate), wherein paraffinic MES is particularly preferred, and vegetable oils, wherein rapeseed oil is particularly preferred, in the production of a self-sealing tire sealant.
